(19) United States
(12) Patent Application Publication
(10) Pub. No.: US 2026/0179320 A1
(43) Pub. Date: Jun. 25, 2026

(54) VIRTUAL OBJECT INJECTION SYSTEM AND METHOD

(71) Applicant: KOREA ELECTRONICS TECHNOLOGY INSTITUTE, Seongnam-si (KR)

(72) Inventors: Suk Woo JUNG, Suwon-si (KR); Kyung Taek LEE, Seongnam-si (KR)

(21) Appl. No.: 19/426,989

(22) Filed: Dec. 19, 2025

(30) Foreign Application Priority Data
Dec. 23, 2024 (KR) 10-2024-0194181

(51) Int. Cl. G06T 17/05; G06T 7/579; G06T 15/60; G06T 19/20

(52) U.S. Cl. CPC G06T 17/05; G06T 7/579; G06T 15/60; G06T 19/20; G06T 2219/2004

(57) ABSTRACT

A virtual object injection system and method are proposed. The system may generate a 3D map for a designated space and a virtual object positioned on the 3D map, acquires a real-time image of the designated space through a stereo camera, and generate 3D environment data, which is defined by a local coordinate system, based on the real-time image. Additionally, the system may align the 3D map and the 3D environment data and convert the coordinate system of the 3D environment data into a global coordinate system. Furthermore, the system may specify a position where the virtual object is to be injected on the 3D environment data, projects the virtual object onto a plane, form a shadow on the virtual object based on depth information of the real-time image and the virtual object, and inject the shadow-formed virtual object into the real-time image.

### CROSS REFERENCE TO RELATED APPLICATION

The present application claims priority to Korean Patent Application No. 10-2024-0194181 filed on Dec. 23, 2024 in the Korean Intellectual Property Office, the entire contents of which are incorporated herein for all purposes by this reference.

### BACKGROUND

### Technical Field

The present disclosure relates to a system and method for injecting a virtual object, and more particularly, to a virtual object injection system and method based on image processing technology for accurately injecting a virtual object into a specific location of an image captured in a real environment.

### Description of Related Technology

The technology for injecting virtual objects, such as virtual things, text, and graphic elements, into images of a real environment is a core technology in augmented reality (AR).

The virtual object injection technology primarily involves injecting virtual objects, created using 3D modeling, into real-time images of the real environment analyzed through a deep learning model. For this purpose, alignment (or registration) between the virtual coordinate system and the coordinate system of the real-time image is required.

### SUMMARY

One aspect is a virtual object injection system and method capable of accurately aligning the position between the virtual coordinate system and the coordinate system of the real-time image and enabling the virtual object to be injected into the real-time image realistically and with a sense of depth (three-dimensionality).

Another aspect is a virtual object injection system that includes a virtual data generation unit configured to generate a three-dimensional (3D) map for a designated space and a virtual object positioned on the 3D map; a real-time data generation unit configured to acquire a real-time image of the designated space through a stereo camera and generate 3D environment data, which is defined by a local coordinate system, based on the real-time image; a coordinate system conversion unit configured to align the 3D map and the 3D environment data and convert the coordinate system of the 3D environment data into a global coordinate system; and a virtual object injection unit configured to specify a position where the virtual object is to be injected on the 3D environment data, project the virtual object onto a plane, form a shadow on the virtual object based on depth information of the real-time image and the virtual object, and inject the shadow-formed virtual object into the real-time image.

In the system, the virtual data generation unit may generate the 3D map through 3D scanning.

In the system, the real-time data generation unit may generate the 3D environment data through a simultaneous localization and mapping (SLAM) technique.

In the system, the coordinate system transformation unit may calculate a transformation matrix based on a difference between the 3D map and the 3D environment data, and apply the transformation matrix to the 3D environment data to convert the coordinate system of the 3D environment data into the global coordinate system.

Another aspect is a virtual object injection method that includes, by a virtual object injection system, generating a three-dimensional (3D) map for a designated space and a virtual object positioned on the 3D map; by the virtual object injection system, acquiring a real-time image of the designated space through a stereo camera and generating 3D environment data, which is defined by a local coordinate system, based on the real-time image; by the virtual object injection system, aligning the 3D map and the 3D environment data to convert the coordinate system of the 3D environment data into a global coordinate system; by the virtual object injection system, specifying a position where the virtual object is to be injected on the 3D environment data, and projecting the virtual object onto a plane; and by the virtual object injection system, forming a shadow on the virtual object, based on depth information of the real-time image and the virtual object, and injecting the shadow-formed virtual object into the real-time image.

In the method, the virtual object injection system may generate the 3D map through 3D scanning.

In the method, the virtual object injection system may generate the 3D environment data through a simultaneous localization and mapping (SLAM) technique.

In the method, the virtual object injection system may calculate a transformation matrix based on a difference between the 3D map and the 3D environment data, and apply the transformation matrix to the 3D environment data to convert the coordinate system of the 3D environment data into the global coordinate system.

According to an embodiment of the present disclosure, the virtual object injection system can accurately match the positions of a real environment and a virtual space by aligning static 3D map data with dynamic 3D environment data and generating global coordinates of the 3D environment data.

Furthermore, the virtual object injection system can realistically reflect shading on a virtual object injected into a real-time image by accurately matching the positions of the real environment and the virtual space and considering the position and direction of a real light source.

### BRIEF DESCRIPTION OF THE DRAWINGS

FIG. 1 is a block diagram illustrating a virtual object injection system according to an embodiment of the present disclosure.

FIG. 2 is a diagram illustrating an example of global coordinate generation for 3D environment data in a virtual object injection system according to an embodiment of the present disclosure.

FIG. 3 is a flowchart illustrating a virtual object injection method according to an embodiment of the present disclosure.

### DETAILED DESCRIPTION

Generally, the virtual object injection technology calculates the position of the virtual object by fusing the simultaneous localization and mapping (SLAM) technology and various sensors, such as global positioning system (GPS). This method requires significant computational resources for real-time data processing and is prone to position errors. Particularly, since the process of injecting a virtual object through a deep learning model involves complex calculations, issues such as the virtual object responding late or shaking on the screen may occur when the user moves the user's viewpoint.

Furthermore, injecting a virtual object into a real-time image without considering the depth information and lighting conditions of the real world can cause problems such as the virtual object unnaturally floating in the real-time image, or the virtual object that should be occluded by a real thing appears in front of it.

Therefore, there is a need for research on technology that accurately aligns the position between the virtual coordinate system and the real-time image coordinate system and enables the virtual object to be injected into the real-time image realistically and with a sense of depth (three-dimensionality).

Now, embodiments of the present disclosure will be described in detail with reference to the accompanying drawings. However, in the following description and the accompanying drawings, well known techniques may not be described or illustrated in detail to avoid obscuring the subject matter of the present disclosure. Through the drawings, the same or similar reference numerals denote corresponding features consistently.

The terms and words used in the following description, drawings and claims are not limited to the bibliographical meanings thereof and are merely used by the inventor to enable a clear and consistent understanding of the disclosure. Thus, it will be apparent to those skilled in the art that the following description about various embodiments of the present disclosure is provided for illustration purpose only and not for the purpose of limiting the disclosure as defined by the appended claims and their equivalents.

In addition, the terms used herein are only examples for describing a specific embodiment and do not limit various embodiments of the present disclosure. The singular expressions may include plural expressions unless the context clearly dictates otherwise. Also, the terms “comprise”, “include”, “have”, and derivatives thereof refer to inclusion without limitation. That is, these terms are intended to specify the presence of features, numerals, steps, operations, elements, components, or combinations thereof, which are disclosed herein, and should not be construed to preclude the presence or addition of other features, numerals, steps, operations, elements, components, or combinations thereof.

The terms such as “unit” and “module” used herein refer to a unit that processes at least one function or operation and may be implemented with hardware, software, or a combination of hardware and software. In addition, the terms “a”, “an”, “one”, “the”, and similar terms are used herein in the context of describing the present disclosure (especially in the context of the following claims) may be used as both singular and plural meanings unless the context clearly indicates otherwise.

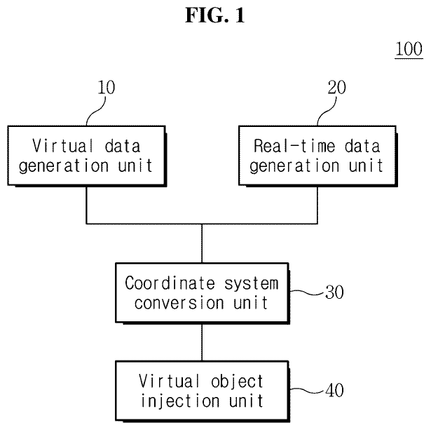

FIG. 1 is a block diagram illustrating a virtual object injection system according to an embodiment of the present disclosure.

Referring to FIG. 1, the virtual object injection system 100 includes a virtual data generation unit (or a virtual data generation processor) 10 configured to generate a three-dimensional (3D) map for a designated space and a virtual object, a real-time data generation unit (or a real-time data generation processor) 20 configured to acquire a real-time image of the designated space through a stereo camera and generate 3D environment data, a coordinate system conversion unit (or a coordinate system conversion processor) 30 configured to align the 3D map and the 3D environment data and thereby convert the coordinate system of the 3D environment data into a global coordinate system, and a virtual object injection unit (or a virtual object injection processor) 40 configured to form a shadow on the virtual object and inject the shadow-formed virtual object into the real-time image.

Hereinafter, the configuration of the virtual object injection system 100 will be described in more detail.

The virtual data generation unit 10 may generate a 3D map by converting the physical structure of the designated space into a 3D model. Specifically, the virtual data generation unit 10 may generate the 3D map, which is static data, through 3D scanning such as laser scanning, light detection and ranging (LiDAR, also referred to as laser imaging, detection, and ranging), structured light, or image-based scanning (e.g., photogrammetry). The 3D map may reflect the state of the designated space at a specific point in time.

For example, the virtual data generation unit 10 may acquire point cloud data through 3D scanning, and form a mesh, which is a continuous surface structure, by connecting the points based on the point cloud data. In this case, the position of all data in the 3D map may be defined by a global coordinate system represented based on a fixed origin (0, 0, 0). The axes of the global coordinate system are fixed and may represent the absolute position and direction in the 3D space. That is, the coordinates for a specific position in the 3D map may be fixed even if the viewpoint moves or rotates. Furthermore, the virtual data generation unit 10 may generate a high-precision 3D map with enhanced visual realism by mapping colors, patterns, and textures to the mesh.

In addition, the virtual data generation unit 10 may update the 3D map periodically to reflect the changing real environment, and may maintain data consistency by compensating for accumulated errors.

The virtual data generation unit 10 may generate a virtual object positioned on the 3D map. The virtual object includes virtual things, text, graphic elements, etc., and may be generated through 3D modeling. For example, the virtual object may be virtual furniture used by a user to arrange furniture after scanning a space inside a house, virtual clothing that the user can wear on the body, a virtual game character that can interact in the real space, and the like. The virtual data generation unit 10 may define the size, position, and orientation of the virtual object in the global coordinate system and place it on the 3D map.

The real-time data generation unit 20 may acquire a real-time image of the designated space through a stereo camera. The stereo camera may capture the same space from two different viewpoints, using two cameras, and generate a real-time image with depth information using the disparity between the two cameras. The real-time data generation unit 20 may further include an inertial measurement unit (IMU) sensor, etc. in addition to the stereo camera, but is not limited thereto.

In addition, the real-time data generation unit 20 may generate 3D environment data by converting the physical structure of the designated space into a 3D model, based on the real-time image. Specifically, the real-time data generation unit 20 may generate 3D environment data, which is dynamic data that changes according to the camera's viewpoint, through the simultaneous localization and mapping (SLAM) technique.

For example, the real-time data generation unit 20 may extract feature points from the real-time image generated by the stereo camera and match the same feature points between consecutive images to generate 3D environment data. Furthermore, the real-time data generation unit 20 may estimate the current position and orientation of the camera, based on the matching results of the feature points.

In this case, the 3D environment data may be defined by a local coordinate system, which represents the relative position and orientation of objects centered on the camera's position. That is, in the 3D environment data, the coordinates for a specific position change according to the movement of the camera, which presents a limitation in accurately specifying a desired position.

Therefore, the virtual object injection system 100 according to the embodiment may accurately match the positions of the real environment and the virtual space by aligning the 3D map, which is static data, and the 3D environment data, which is dynamic data, and generating global coordinates for the 3D environment data.

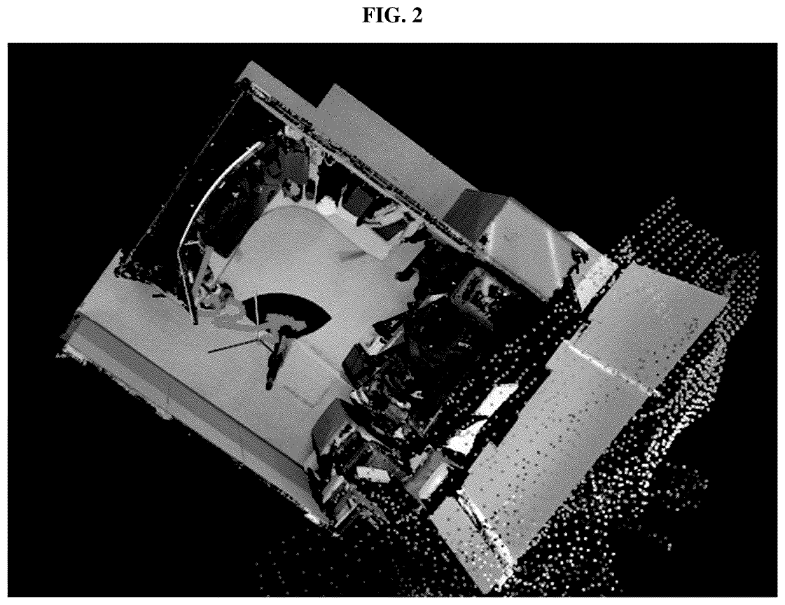

Specifically, the coordinate system conversion unit 30 may calculate a transformation matrix, based on the difference between the 3D map and the 3D environment data. For example, the coordinate system conversion unit 30 may extract and match feature points between the 3D map and the 3D environment data, and calculate the transformation matrix based on the common feature points. Furthermore, the coordinate system conversion unit 30 may align the 3D map and the 3D environment data by applying the transformation matrix to the 3D environment data, and generate a global coordinate system for the 3D environment data. FIG. 2 is a view illustrating an example of generating global coordinates for the 3D environment data in the virtual object injection system 100 according to the embodiment. The global coordinates for the 3D environment data may serve as a reference point for integrating the 3D map and the real-time image.

The virtual object injection unit 40 may specify a position on the 3D environment data where the virtual object is to be injected, and project the virtual object onto a plane. For example, the virtual object injection unit 40 may convert the global coordinates of the virtual object into the camera coordinate system to specify the position where the virtual object is to be injected on the 3D environment data, and project the virtual object onto the screen coordinate system using the camera's intrinsic parameters.

The virtual object injection unit 40 may form a shadow on the virtual object, based on depth information of the real-time image and the virtual object. For example, the virtual object injection unit 40 may acquire the global coordinates and the direction vector for the position of a light source from the 3D environment data. The virtual object injection unit 40 may project the shadow of the virtual object onto a plane, and naturally represent the shadow by generating a texture and applying transparency to the shadow area.

That is, by accurately matching the positions of the real environment and the virtual space, the virtual object injection system 100 according to the embodiment can realistically reflect a shadow on the virtual object being injected into the real-time image, considering the position and direction of the real light source.

Hereinafter, a virtual object injection method according to an embodiment will be described in detail.

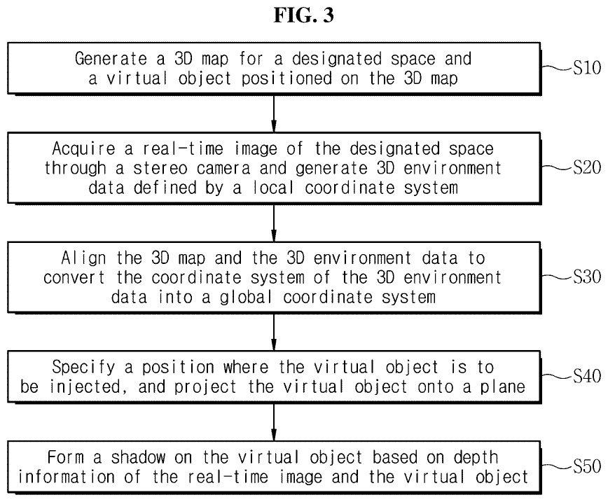

FIG. 3 is a flowchart illustrating a virtual object injection method according to an embodiment of the present disclosure.

Referring to FIG. 3, the virtual object rendering method begins with step S10 in which the virtual object injection system 100 generates a 3D map for a designated space and a virtual object positioned on the 3D map.

The 3D map may be static data generated through 3D scanning such as laser scanning, LiDAR, structured light, image-based scanning (e.g., photogrammetry), etc. The virtual object includes virtual things, text, graphic elements, etc., and may be generated through 3D modeling. In this case, the virtual object injection system 100 may define the position of all data of the 3D map and the virtual object by a global coordinate system represented based on a fixed origin (0, 0, 0).

Next, in step S20, the virtual object injection system 100 acquires a real-time image of the designated space through a stereo camera and generates 3D environment data defined by a local coordinate system.

Specifically, the 3D environment data is generated based on the real-time image including depth information and may be generated through the SLAM technique. For example, the virtual object injection system 100 may extract feature points from the real-time image generated by the stereo camera and match the same feature points between consecutive images to generate 3D environment data. In this case, the virtual object injection system 100 may define the 3D environment data by a local coordinate system, which represents the relative position and orientation of objects centered on the camera's position. Furthermore, the virtual object injection system 100 may estimate the current position and orientation of the camera, based on the matching results of the feature points.

Next, in step S30, the virtual object injection system 100 aligns the 3D map and the 3D environment data to convert the coordinate system of the 3D environment data into a global coordinate system.

Specifically, the virtual object injection system 100 may calculate a transformation matrix, based on the difference between the 3D map and the 3D environment data, and apply it to the 3D environment data to convert the coordinate system of the 3D environment data into a global coordinate system. That is, the virtual object injection system 100 may accurately match the positions of the real environment and the virtual space by aligning the 3D map, which is static data, and the 3D environment data, which is dynamic data, and generating global coordinates for the 3D environment data.

Next, in step S40, the virtual object injection system 100 specifies a position where the virtual object is to be injected, and projects the virtual object onto a plane.

For example, the virtual object injection system 100 may convert the global coordinates of the virtual object into the camera coordinate system to specify the position where the virtual object is to be injected on the 3D environment data, and project the virtual object onto the screen coordinate system using the camera's intrinsic parameters.

Finally, in step S50, the virtual object injection system 100 forms a shadow on the virtual object, based on the depth information of the real-time image and the virtual object, and injects the shadow-formed virtual object into the real-time image.

For example, the virtual object injection system 100 may acquire the global coordinates and the direction vector for the position of a light source from the 3D environment. Additionally, the virtual object injection system 100 may project the shadow of the virtual object onto a plane, and naturally represent the shadow by generating a texture and applying transparency to the shadow area.

While the present disclosure has been particularly shown and described with reference to an exemplary embodiment thereof, it will be understood by those skilled in the art that various changes in form and details may be made therein without departing from the scope of the present disclosure as defined by the appended claims.

Research related to the present disclosure was carried out as part of the project titled “Development of Autonomous Driving Simulation Technology based on Multi-Parallel Processing for Advancement of Fully Autonomous Driving Algorithm” (Project ID: 1415190017, Project No.: P0026022), which is funded by the Ministry of Trade, Industry and Energy (MOTIE) and administered by the Korea Institute for Advancement of Technology (KIAT).

What is claimed is:

1. A virtual object injection system comprising:
a virtual data generation processor configured to generate a three-dimensional (3D) map for a designated space and a virtual object positioned on the 3D map;
a real-time data generation processor configured to acquire a real-time image of the designated space through a stereo camera and generate 3D environment data, which is defined by a local coordinate system, based on the real-time image;
a coordinate system conversion processor configured to align the 3D map and the 3D environment data and convert the coordinate system of the 3D environment data into a global coordinate system; and
a virtual object injection processor configured to specify a position where the virtual object is to be injected on the 3D environment data, project the virtual object onto a plane, form a shadow on the virtual object based on depth information of the real-time image and the virtual object, and inject the shadow-formed virtual object into the real-time image.

2. The system of claim 1, wherein the virtual data generation processor is configured to generate the 3D map through 3D scanning.

3. The system of claim 1, wherein the real-time data generation processor is configured to generate the 3D environment data through a simultaneous localization and mapping (SLAM) technique.

4. The system of claim 1, wherein the coordinate system transformation processor is configured to calculate a transformation matrix based on a difference between the 3D map and the 3D environment data, and apply the transformation matrix to the 3D environment data to convert the coordinate system of the 3D environment data into the global coordinate system.

5. A virtual object injection method comprising:
by a virtual object injection system, generating a three-dimensional (3D) map for a designated space and a virtual object positioned on the 3D map;
by the virtual object injection system, acquiring a real-time image of the designated space through a stereo camera and generating 3D environment data, which is defined by a local coordinate system, based on the real-time image;
by the virtual object injection system, aligning the 3D map and the 3D environment data to convert the coordinate system of the 3D environment data into a global coordinate system;
by the virtual object injection system, specifying a position where the virtual object is to be injected on the 3D environment data, and projecting the virtual object onto a plane; and
by the virtual object injection system, forming a shadow on the virtual object, based on depth information of the real-time image and the virtual object, and injecting the shadow-formed virtual object into the real-time image.

6. The method of claim 5, wherein the virtual object injection system generates the 3D map through 3D scanning.

7. The method of claim 5, wherein the virtual object injection system generates the 3D environment data through a simultaneous localization and mapping (SLAM) technique.

8. The method of claim 5, wherein the virtual object injection system calculates a transformation matrix based on a difference between the 3D map and the 3D environment data, and applies the transformation matrix to the 3D environment data to convert the coordinate system of the 3D environment data into the global coordinate system.
